(19) United States
(12) Patent Application Publication
(10) Pub. No.: US 2004/0064686 A1
(43) Pub. Date: Apr. 1, 2004

(54) Method and apparatus for marking current memory configuration

(76) Inventors: Gregory L. Miller, Portland, OR (US); Nicholas J. Yoke, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/262,584

(22) Filed: Sep. 30, 2002

(51) Int. Cl. G06F 9/00

(52) U.S. Cl. 713/1

(57) ABSTRACT

A method and apparatus for marking current memory configuration is presented. In this regard, an enhanced Basic Input/Output System (BIOS) is introduced to initialize system memory during an initial boot and to store initialization settings in a non-volatile memory for use during a subsequent boot.

### TECHNICAL FIELD

The present invention generally relates to the field of computing devices and, more particularly, to a method and apparatus for marking current memory configuration.

### BACKGROUND

Because of their fast processors, computing devices are expected to power-on (colloquially referred to as boot) very quickly. A computing device that takes more than ten seconds from power-on to operating system (OS) loading is now considered slow.

A substantial portion of the boot time is normally spent on memory initialization. The basic input/output system software (BIOS) of the computing device performs routines to determine the size and optimum speed of the computing device's system memory configuration and then configures certain operational attributes, e.g., in the memory controller, accordingly to be able to interface with the system memory.

Many memory manufacturers include information about their memory modules in serial presence detect (SPD) devices that record specific information about the type, size and speed of the module. This information can be read and used by the BIOS to aid in determining the proper values to program the computing device's memory controller. Currently, these initialization settings are recalculated during every boot because it is not known if the memory configuration has changed from boot to boot.

### BRIEF DESCRIPTION OF THE DRAWINGS

Embodiments of the present invention are illustrated by way of example, and not by way of limitation, in the figures of the accompanying drawings in which like reference numerals refer to similar elements and in which:

FIG. 1 is a block diagram of an example computing device suitable for implementing the enhanced BIOS, in accordance with one example embodiment of the invention;

FIG. 2 is a block diagram of an example enhanced BIOS, in accordance with one example embodiment of the invention;

FIG. 3 is a graphical illustration of an example data structure used in accordance with the enhanced BIOS, in accordance with one example embodiment of the invention; and

FIG. 4 is a flow chart of an example method for implementing an enhanced BIOS, in accordance with one example embodiment of the invention.

### DETAILED DESCRIPTION

Embodiments of the present invention are generally directed to a system and related methods for improving boot times of computing devices. In this regard, an enhanced basic input/output system (BIOS) is presented which employs an innovative method to reduce boot time spent on memory initialization. Those skilled in the art will appreciate, from the description to follow, that the method enabled by the enhanced BIOS facilitates boot time improvements when the memory configuration does not change from one boot instance to another. In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

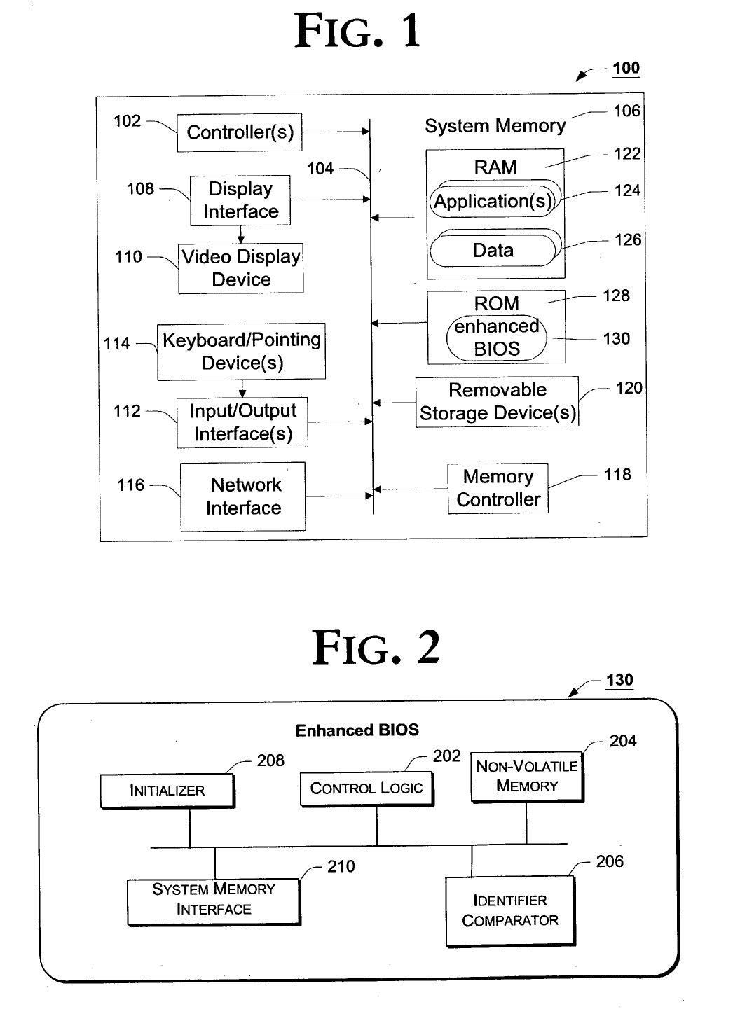

FIG. 1 is a block diagram of an example computing device suitable for implementing the enhanced BIOS, in accordance with one example embodiment of the invention. Computing device 100 includes controller(s) 102, bus 104, system memory 106, display interface 108, video display interface 110, input/output interface(s) 112, keyboard/pointing device(s) 114, enhanced network interface 116, memory controller 118, removable storage device(s) 120, RAM 122, application(s) 124, data 126, ROM 128, and enhanced BIOS 130 coupled as shown in FIG. 1. The enhanced BIOS 130 as described more fully hereinafter, may well be used in computing devices of greater or lesser complexity than that depicted in FIG. 1. Also, the innovative detection and configuration attributes of enhanced BIOS 130 as described more fully hereinafter may well be embodied in a combination of hardware and software.

Computing device 100 includes controller(s) 102 for processing information. An example of a controller 102 is a processor. As used herein, controller(s) 102 control the overall operation of computing device 100. Computing device 100 further includes bus 104, which is coupled with controller 102, to facilitate the transfer of data within computing device 100.

Random access memory (RAM) 122 comprises system memory 106 that is coupled with bus 104 for storing information and instructions to be executed by controller 102. System memory 106 also can be used for storing temporary variables or other intermediate information during execution of instructions by controller 102. Typically, applications 124 and data 126 are stored in RAM 122 when they have been or will soon be used by controller 102, because of the quick access capabilities of RAM 122. RAM 122 may comprise any of a number of dynamic random access memory (DRAM) technologies available. In one embodiment, RAM 122 comprises Direct Rambus™ DRAM (RDRAM). In an alternate embodiment, RAM 122 comprises double data rate synchronous DRAM (DDR SDRAM). System memory 106 has to be initialized, in this case by enhanced BIOS 130, on every boot, because it is possible for a user to add memory modules to and/or remove memory modules from system memory 106 prior to powering on computing device 100. RDRAM and DDR SDRAM modules typically include serial presence detect (SPD) devices that store information about the module to assist in the initialization process. These SPD devices typically can store 128 or 256 bytes of information and are accessed by a system management bus (SMBUS). One skilled in the art would appreciate that the SMBUS provides relatively slow transfers, and reducing the number of SMBUS reads during memory initialization can improve boot times.

ROM 128 is typically non-volatile and has the ability to retain its contents while using little or no power. In one embodiment, ROM 128 is a plurality of complimentary metal-oxide silicon (CMOS) memories. In an alternate embodiment, ROM 128 is a flash memory. Typically, ROM 128 is used to store enhanced BIOS 130, which is a software program that enables computing device 100 to function by initializing components, i.e. system memory 106, when computing device 100 is powered on. Enhanced BIOS 130 includes functionality to initialize system memory 106 as presented more fully with reference to FIG. 2. Enhanced BIOS 130 is typically copied to RAM 122 when computing device 100 is first powered on for quick access at any time. ROM 128 can also be used to store system memory initialization settings and unique identifiers as presented more fully with reference to FIG. 2.

Computing device 100 includes display interface 108, which in turn is coupled with video display device 110, such as a cathode ray tube (CRT) or liquid crystal display (LCD), for displaying information to a computing device user. Keyboard/pointing device(s) 114, including alphanumeric and other keys and a mouse, a trackball, or cursor direction keys, are typically coupled with bus 104 via an input/output interface 112 for communicating information, command selections, and cursor movement to controller 102.

Computing device 100 further includes network interface 116 that provides access to a network (not shown in FIG. 1). In one embodiment, network interface 116 is a network interface card (NIC); however, other network interfaces can also be used

Bus 104 can be a single bus or a plurality of busses that provide interconnection to the components of computing device 100. In one embodiment bus 104 includes separate busses exclusively for memory access and display access, as well as a SMBUS.

Memory controller 118, which can either be incorporated in a chipset or a separate component, gives coupled components access to system memory 106 as needed. Memory controller 118 is loaded with initialization settings during the power-on (boot) process by enhanced BIOS 130. These initialization settings should allow memory controller 118 to store data to and retrieve data from system memory 106 at the optimal speed that the memory modules support.

Removable storage device(s) 120, such as a floppy disk drive, CD-ROM drive, or hard drive, provide high capacity storage of applications and data that may be needed by controller 102.

FIG. 2 is a block diagram of an example enhanced BIOS, in accordance with one example embodiment of the invention. As shown, enhanced BIOS 130 includes control logic 202, non-volatile memory 204, identifier comparator 206, initializer 208, and system memory interface 210 coupled as shown in FIG. 2. FIG. 2 is meant to facilitate ease of understanding, however one skilled in the art would appreciate that each of the components of enhanced BIOS 130 may not be separate components as shown.

Control logic 202 controls the activities of the other components of enhanced BIOS 130. In this regard, according to one example embodiment, control logic 202 facilitates the example method that is presented more fully in reference to FIG. 4.

Non-volatile memory 204 may be a CMOS memory, however, the claimed subject matter is not limited in scope in this respect. Non-volatile memory 204 stores the system memory initialization setting(s) and unique identifier(s) for the memory modules present in computing device 100. These settings and identifiers can be retrieved and utilized on subsequent boots, because of the non-volatile nature of non-volatile memory 204. In other words, the data in non-volatile memory 204 will remain intact even when power has been removed from computing device 100.

According to one example embodiment, control logic 202 invokes an instance of identifier comparator 206 to determine whether the memory configuration has changed from the memory configuration of a prior boot. In one embodiment, identifier comparator 206 compares a unique identifier stored in non-volatile memory 204 with an identifier stored on a memory module's SPD device.

Initializer 208 is selectively invoked to initialize the system memory 106, and/or to program system memory initialization settings into memory controller 118. In one embodiment, initializer 208 reads and interprets data read from each memory module's SPD devices. Based on this data obtained from the SPD devices, initializer 208 determines the initialization settings that need to be programmed into memory controller 118 in order to optimize memory accesses. In another embodiment, initializer 208 performs diagnostic memory tests with potential initialization settings to determine what the optimal initialization settings should be.

System memory interface 210 provides access to the SPD devices on each of the system memory modules. In one embodiment, system memory interface 210 is an SMBUS interface. System memory interface 210 includes the ability to read from as well as to write to the SPD devices of the memory modules.

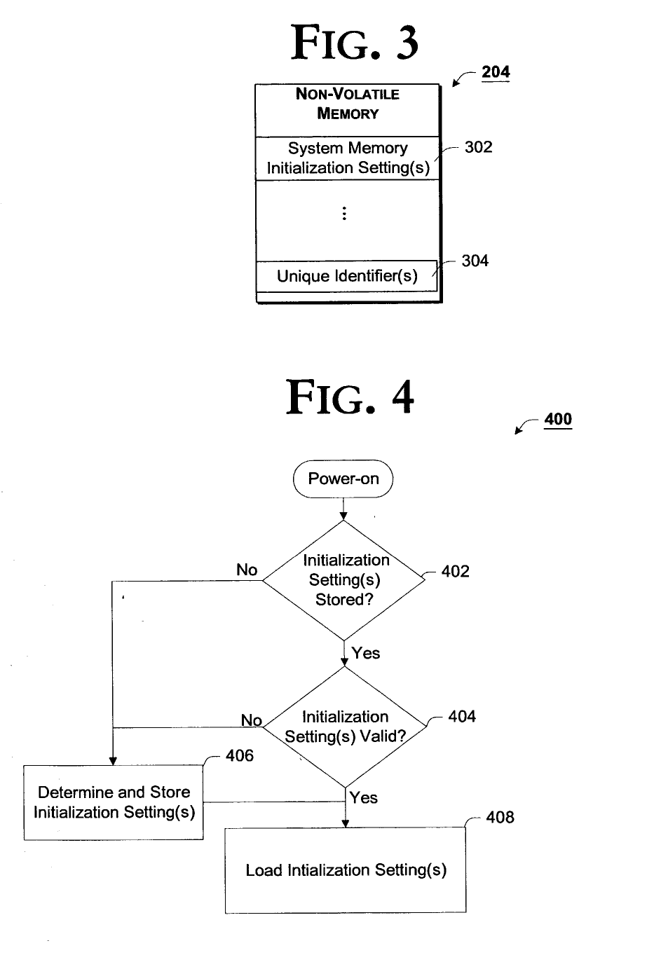

FIG. 3 is a graphical illustration of an example data structure used in accordance with the enhanced BIOS, in accordance with one example embodiment of the invention. Non-volatile memory 204 stores system memory initialization setting(s) 302 and unique identifier(s) 304. System memory initialization setting(s) 302 includes those values that need to be programmed by enhanced BIOS 130 into memory controller 118, in order for memory controller 118 to optimally interface with system memory 106. To provide some examples, although, of course, the claimed subject matter is not limited in scope in this respect, the system memory initialization setting(s) 302 may include buffer strength settings and refresh period settings. Unique identifiers 304 are stored for each memory module present in computing device 100. To provide some examples, although, of course, the claimed subject matter is not limited in scope in this respect, the unique identifier(s) 304 may be based on a date and time stamp or a memory module's serial number.

FIG. 4 is a flow chart of an example method for implementing an enhanced BIOS, in accordance with one example embodiment of the invention. Enhanced BIOS 130 executes method 400 every time computing device 100 is booted. The method begins with step 402 wherein control logic 202 determines whether system memory initialization setting(s) are stored in non-volatile memory 204. If there are no system memory initialization setting(s) 302 stored in non-volatile memory 204, then step 406, which is presented more fully hereinafter, is performed. If there are system memory initialization setting(s) 302 stored in non-volatile memory 204, then step 404 is performed.

In step 404, control logic 202 determines whether the system memory initialization setting(s) stored in non-volatile memory 204 during a prior boot are still valid for use during the current boot. One reason why the system memory initialization setting(s) 302 would not be valid for use during the current boot is if the current system memory 106 configuration is different from the memory configuration for which the system memory initialization setting(s) 302 were generated.

In one embodiment, control logic 202 determines whether the system memory initialization setting(s) 302 stored in non-volatile memory 204 are valid by retrieving unique identifier(s) for each memory module from both non-volatile memory 204 and also from the memory module's SPD device. Control logic 202 sends these two unique identifiers for each memory module to identifier comparator 206 to determine if they match. If all the unique identifiers 304 stored in non-volatile memory 204 match the unique identifiers stored on the corresponding memory module's SPD device and there are not new memory module(s) present, then control logic 202 considers the system memory initialization setting(s) 302 to be valid.

In another embodiment, control logic 202 determines whether the system memory initialization setting(s) 302 stored in non-volatile memory 204 are valid by having initializer 208 perform diagnostic tests with the stored system memory initialization setting(s) 302. If the diagnostic tests pass, then control logic 202 considers the system memory initialization setting(s) 302 to be valid.

In yet another embodiment, control logic 202 determines whether the system memory initialization setting(s) 302 stored in non-volatile memory 204 are valid based on a signal from another component of computing device 100, including, for example, a user entered input.

If control logic 202 determines that the stored system memory initialization setting(s) are valid, then control logic 202 has initializer 208 load these setting(s) into memory controller 118 (step 408).

If there are no system memory initialization setting(s) 302 stored in non-volatile memory 204 (as per step 402), or if the system memory initialization setting(s) 302 stored in non-volatile memory 204 are not valid (as per step 404), then control logic 202 has initializer 208 determine the optimal initialization setting(s) for the current system memory 106 configuration and stores these setting(s) in non-volatile memory 204 for use during future boots (step 406). One skilled in the art would appreciate that performing step 406 does not provide any boot time improvements over current memory initialization methods, because those known methods are used in step 406. However, by storing the initialization setting(s) 302 to non-volatile memory 204, boot time improvements can be realized on subsequent boots, for which the system memory 106 configuration does not change, by not having to perform step 406.

Also in step 406, for those embodiments that utilize unique identifier(s) to determine the validity of system memory initialization setting(s) 302 stored in non-volatile memory 204, control logic 202 stores a unique identifier 304 for each memory module in non-volatile memory 204. In one embodiment, the unique identifier is generated based at least in part on the current date and time, and is further written to the SPD area of the corresponding memory module. In another embodiment, the unique identifier is a serial number that had been written to the SPD area of the memory module by the manufacturer.

Lastly, in step 408, control logic 202 has initializer 208 program memory controller 118 with the system memory initialization setting(s) 302 either that were determined to be valid in step 404 or that were generated by initializer 208 in step 406.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
initializing system memory during an initial boot; and
storing initialization settings in a non-volatile memory for use during a subsequent boot.

2. The method of claim 1, further comprising:
loading the stored initialization settings during a subsequent boot without re-initializing if it is determined that the system memory has not changed.

3. The method of claim 2, wherein storing initialization settings in a non-volatile memory comprises writing to a complimentary metal-oxide silicon (CMOS) memory.

4. The method of claim 2, further comprising:
generating a unique identifier for each memory module during the initial boot; and
writing the unique identifier(s) to the non-volatile memory;

5. The method of claim 4, further comprising:
determining whether the system memory has changed during the subsequent boot by comparing the unique identifier(s) of each memory module with the unique identifier(s) stored in the non-volatile memory.

6. The method of claim 4, further comprising writing the unique identifier(s) to a serial presence detect (SPD) device on the associated memory module(s).

7. The method of claim 4, wherein generating a unique identifier comprises generating a time and date stamp.

8. A machine-readable medium having stored thereon sequences of instructions that when executed by one or more processors cause the one or more processors to:
initialize system memory during an initial boot; and
store initialization settings in a non-volatile memory for use during a subsequent boot.

9. The machine-readable medium of claim 8 further comprising sequences of instructions that when executed cause the one or more processors to load the stored initialization settings during a subsequent boot without re-initializing if it is determined that the system memory has not changed.

10. The machine-readable medium of claim 9 the sequence of instructions that when executed cause the one or more processors to store initialization settings in a non-volatile memory comprises sequences of instructions that when executed cause the one or more processors to write to complimentary metal-oxide silicon (CMOS) memory.

11. The machine-readable medium of claim 9 further comprising sequences of instructions that when executed cause the one or more processors to:
generate a unique identifier for each memory module during the initial boot; and
write the unique identifier(s) to the non-volatile memory.

12. The machine-readable medium of claim 11 further comprising sequences of instructions that when executed cause the one or more processors to determine whether the system memory has changed during the subsequent boot by comparing the unique identifier(s) of each memory module with the unique identifier(s) stored in the non-volatile memory.

13. The machine-readable medium of claim 11 further comprising sequences of instructions that when executed cause the one or more processors to write the unique identifier(s) to a serial presence detect (SPD) memory on the associated memory module(s).

14. The machine-readable medium of claim 11 wherein the sequences of instructions that when executed cause the one or more processors to generate a unique identifier comprises sequences of instructions that when executed cause the one or more processors to generate a time and date stamp.

15. A computing device comprising:
means for initializing system memory during an initial boot; and
means for storing initialization settings in a non-volatile memory for use during a subsequent boot.

16. The computing device of claim 15 further comprising
means for determining if the system memory has changed; and
means for loading the stored initialization settings during a subsequent boot without re-initializing if the system memory has not changed.

17. The computing device of claim 16 wherein the means for storing initialization settings in a non-volatile memory comprises means for writing to complimentary metal-oxide silicon (CMOS).

18. The computing device of claim 16 further comprising:
means for generating a unique identifier for each memory module during the initial boot; and
means for writing the unique identifier(s) the non-volatile memory.

19. The computing device of claim 18 wherein the means for determining if the system memory has changed comprises means for comparing the unique identifier(s) of each memory module with the unique identifier(s) stored in the non-volatile memory.

20. The computing device of claim 18 further comprising means for writing the unique identifier(s) to a serial presence detect (SPD) memory on the associated memory module(s).

21. The computing device of claim 18 wherein the means for generating a unique identifier comprises means for generating a time and date stamp.

22. An apparatus comprising:
a dynamic memory;
a non-volatile memory; and
a basic input/output system (BIOS) to initialize the dynamic memory during an initial boot and to store initialization settings in the non-volatile memory for use during a subsequent boot.

23. The apparatus of claim 22 wherein the BIOS is configured to load the stored initialization settings during a subsequent boot without re-initializing if it is determined that the dynamic memory has not changed.

24. The apparatus of claim 23 wherein the non-volatile memory comprises complimentary metal-oxide silicon (CMOS) memory.

25. The apparatus of claim 23 wherein the dynamic memory comprises a non-volatile memory to store one or more unique identifiers generated by the BIOS.

26. The apparatus of claim 25 wherein the BIOS is configured to determine during the subsequent boot whether the dynamic memory has changed by comparing the unique identifier(s) stored in the dynamic memory with unique identifier(s) stored in the non-volatile memory.

27. The apparatus of claim 25 wherein the dynamic memory comprises serial presence detect (SPD) specification compliant memory.

28. The apparatus of claim 25 wherein the BIOS is configured to generate a unique identifier based on a current time and date.
